(19) United States
(12) Patent Application Publication
(10) Pub. No.: US 2018/0373901 A1
(43) Pub. Date: Dec. 27, 2018

(54) ENHANCED LOCK SCREEN SECURITY

(71) Applicant: ALCATEL LUCENT, Nozay (FR)

(72) Inventor: Zhi Wang, Shanghai (CN)

(73) Assignee: Alcatel Lucent, Nozay (FR)

(21) Appl. No.: 16/062,985

(22) PCT Filed: Dec. 17, 2015
(86) PCT No.: PCT/CN2015/097736

§ 371 Date: Jun. 15, 2018

(51) Int. Cl. G06F 21/84; G06F 3/0488; G06F 3/0484

(52) U.S. Cl. CPC G06F 21/84; G06F 2221/2149; G06F 3/04845; G06F 3/04883

(57) ABSTRACT

An apparatus is provided, e.g. a mobile electronic device such as a smart phone, that has a touch-screen, a processor, and a memory. The memory is coupled to the processor, such that the processor can retrieve instructions and data from the memory. The memory contains instructions that when executed configure the processor to implement two unlocking steps. In a first unlocking step, the processor detects a first unlocking pattern based on a first coordinate space of the touch screen. In a second unlocking step, the processor detects a second unlocking pattern based on a second coordinate space of the touch screen that is a distortion of the first coordinate space of the touch screen.

### TECHNICAL FIELD

The present invention relates generally to the field of electronic computing devices, and, more particularly, but not exclusively, to methods and apparatus for improved security of access to such devices using touch screen access.

### BACKGROUND

This section introduces aspects that may be helpful to facilitate a better understanding of the inventions. Accordingly, the statements of this section are to be read in this light and are not to be understood as admissions about what is in the prior art or what is not in the prior art. Any techniques or schemes described herein as existing or possible are presented as background for the present invention, but no admission is made thereby that these techniques and schemes were heretofore commercialized, or known to others besides the inventors.

Mobile security or mobile user security has become increasingly critical in the mobile computing eco-system. It is of particular concern as it correlates to the security of personal and business information now stored on smart phones. As such devices become increasingly integrated into users' activities and lifestyles, more information, often of a very personal nature, is stored on them.

Therefore, it is critically important to increase the difficulty of access to smart electronic devices by unauthorized users to protect legitimate users' content.

### SUMMARY

The inventor discloses various apparatus and methods that may be beneficially applied to, e.g., ensuring secure access to a smart electronic device such as a smart phone. While such embodiments may be expected to provide improvements in performance and/or security of such apparatus and methods, no particular result is a requirement of the present invention unless explicitly recited in a particular claim.

One embodiment provides an apparatus, e.g. a mobile electronic device such as a smart phone, that has a touch-screen, a processor, and a memory. The memory is coupled to the processor, such that the processor can retrieve instructions and data from the memory. The memory contains instructions that when executed configure the processor to implement two unlocking steps. In a first unlocking step, the processor detects a first unlocking pattern based on a first coordinate space of the touch screen. In a second unlocking step, the processor detects a second unlocking pattern based on a second coordinate space of the touch screen that is a distortion of the first coordinate space of the touch screen.

In some embodiments the processor is a component of a portable electronic device, and is further configured by the instructions to unlock the device only on the condition that the first unlocking pattern and the second unlocking pattern are both registered unlocking patterns. In some embodiments the processor is further configured by the instructions to display a first pattern of indicia at coordinate points in the first coordinate space in the first unlocking step, and to display a second pattern of indicia at same coordinate points in the second coordinate space in the second unlocking step. In such embodiments the processor may be further configured to display the first pattern of indicia or the second pattern of indicia in a manner that conveys to a user the type of distortion.

In some embodiments the second unlocking pattern is a distorted version of the first unlocking pattern. In some embodiments the processor is configured to allow access to the apparatus only on the condition that the touch screen registers a first correct unlocking pattern in the first unlocking step, and registers a second correct unlocking pattern in the second unlocking step, wherein the second unlocking pattern is a distorted version of the first unlocking pattern.

In some embodiments the second coordinate space is scaled in at least one dimension relative to the first coordinate space. In some embodiments the second coordinate space is skewed with respect to the first coordinate space. In some embodiments the second coordinate space is rotated with respect to the first coordinate space. In some embodiments the second coordinate space is inverted with respect to the first coordinate space. In some embodiments the second coordinate space is at least two of scaled, skewed, rotated and inverted with respect to the first coordinate space.

In some embodiments the processor is configured to allow a user to specify a sequence of a first unlocking pattern in the first unlocking step and a second unlocking pattern in the second unlocking step required to unlock the apparatus. In some embodiments the processor is further configured to allow a user to specify a maximum duration within which a first unlocking pattern in the first unlocking step and a second unlocking pattern in the second unlocking step must be properly executed to unlock the apparatus.

Other embodiments include methods, e.g. methods of manufacturing, of forming the various apparatus recited above, and methods of operating the various apparatus recited above.

### BRIEF DESCRIPTION OF THE DRAWINGS

A more complete understanding of the present invention may be obtained by reference to the following detailed description when taken in conjunction with the accompanying drawings wherein:

FIG. 1 illustrates an apparatus, e.g. mobile electronic device, having a touch screen a processor, and a memory that includes instructions that configure the processor to execute functions according to various embodiments;

FIG. 2 illustrates an example touch screen with touch points, and an example unlocking pattern in a first coordinate space;

FIG. 3 illustrates an example touch screen layout and an example unlocking pattern in a second coordinate space that is compressed in a vertical dimension relative to the first coordinate space of FIG. 1;

FIG. 4 illustrates an example touch screen layout and an example unlocking pattern in a third coordinate space that is skewed relative to the first coordinate space of FIG. 1;

FIG. 5A illustrates an example touch screen layout and an example unlocking pattern in a fourth coordinate space in which the horizontal axis is reversed relative to the first coordinate space of FIG. 1;

FIG. 5B illustrates the example of FIG. 5A, with indicia displayed at touch points in a manner that conveys to a user the reversal of the horizontal axis;

FIG. 6A illustrates an example touch screen layout and an example unlocking pattern in a fifth coordinate space that is rotated relative to the first coordinate space of FIG. 1;

FIG. 6B illustrates the example of FIG. 6A, with indicia displayed at touch points in a manner that conveys to a user rotation of the coordinate space.

### DETAILED DESCRIPTION

Various embodiments are now described with reference to the drawings, wherein like reference numbers are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

As remarked upon earlier, mobile security remains a topic of intense interest in the user and development communities. Facial recognition, fingerprint, or even voice have been used or proposed for mobile security. However, to support these technologies, new elements and complicated algorithms are sometimes needed, which may not be well-supported by some mobile devices due to device capability and/or cost and/or needed computing resources. For example, a front-facing camera is required for facial recognition, fingerprint unlocking has been defeated, and voice recognition algorithms may fail to reliably determine a user, especially in a high-noise environment.

To address one or more of these deficiencies in conventional technology, the inventor has determined simple but effective apparatus and methods to enhance security on mobile computing devices having a touch screen. These apparatus and methods are expected to add little or no burden to the computing resources of mobile devices.

FIG. 1 presents a schematic illustration of functional aspects of an apparatus 100, e.g. a mobile computing device. The apparatus 100 may be or include, e.g. a smart phone, tablet computer, (e.g. iPad™) or touch-screen computer (e.g. Surface Pro™ or touch-screen laptop). The apparatus 100 includes a processor 110, a memory 120 and a touch screen 130. The processor 110 is configured to communicate with the memory 120 to retrieve and execute instructions to perform one or more embodiments described herein. The memory 120 may also store data related to various embodiments, such as unlocking patterns, as described further below.

The processor 110 is also configured to communicate with the touch screen 130, e.g. to provide display information, and to receive touch information. The touch screen 130 may be used by the apparatus 100 to perform conventional tasks, e.g. making calls or browsing the Internet. In addition to such conventional uses, the touch screen 130 and the processor 110 operate to implement one or more embodiments to unlock the apparatus 100 for use. To support this operation, the processor 110 is configured to recognize several touch points 140 with which the operator may interact to unlock the apparatus 100. For instance the operator may activate a sequence of touch points 140 in one or more unlocking patterns that have been preconfigured to be recognized by the processor 110. Such patterns may be stored by the used in the memory 120, for example.

While conventional pattern entry is a convenient method of unlocking a mobile device, the method may be exploited to gain access to a mobile device. For example, a so-called “smudge attack” involves the recognition by an unauthorized user of an unlocking pattern of smudges left on the mobile device touch screen such as by skin oil. Indeed, the feasibility of such attacks has already been documented.

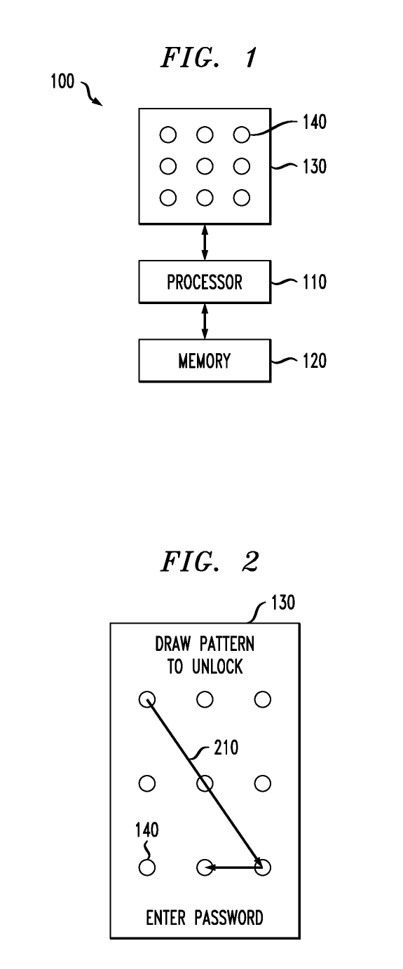

Thus, embodiments described herein provide apparatus and methods to reduce the possibility of a successful smudge attack. Each embodiment requires two inputs from a user attempting to access a touch-screen device. Each input is referred to herein as an “unlocking step”. In a first unlocking step, the user provides a first unlocking pattern, e.g. a pattern that connects two or more of the touch points 140. In the first unlocking pattern the touch points 140 are placed in a first coordinate space of the screen, e.g. a Cartesian coordinate space. In a second unlocking step, the user provides a second unlocking pattern. In the second unlocking pattern the touch points 140 are placed in a second different coordinate space of the screen. More specifically, the second coordinate system may be a distortion of the first coordinate system. This approach is further described with reference to FIGS. 2-6.

FIG. 2 illustrates the touch screen 130 with touch points 140 placed at regular locations of a rectilinear grid, e.g. a Cartesian coordinate space. The locations correspond to coordinate points in the coordinate space. By regular, it is meant that the touch points 140 are arranged such that they form columns and rows. The columns and rows may have a same spacing, forming a square grid, or may not have a same spacing, which results in a rectangular grid. In the example of FIG. 2, the vertical (e.g. “y”) spacing is a bit larger than the horizontal (e.g. “x”) spacing. Embodiments are not limited to a rectilinear grid—for example the coordinate space could be a polar coordinate space. The touch points 140 may optionally be represented by indicia, e.g. the illustrated small circles, but there is no requirement to do so.

An unlocking pattern 210 connects four touch points 140, e.g. upper left, middle, lower-right and bottom middle touch points. Of course, more or fewer touch points may be used, and the unlocking pattern may be more complex, such as including segments that cross earlier segments. The sensitivity of the touch points 140 may be larger or smaller than any indicia. Thus, while the unlocking pattern 210 is shown crossing the perimeters of the illustrated indicia, there is no requirement that it does so. Thus, for example, a particular indicium may have a radius R₁, and the processor 110 may be configured to interpret a touch within a larger radius R₂>R₁ as contacting that indicium. The sensitivity of the indicia may be adjustable, and need not be the same for all indicia.

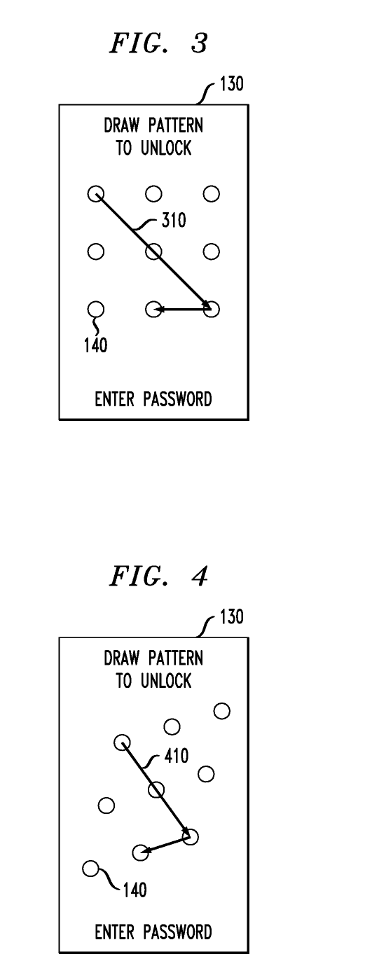

FIG. 3 illustrates the touch screen 130 with touch points 140 placed in a different coordinate space than that used in FIG. 2. While still a rectilinear coordinate space, the coordinate space of FIG. 3 is distorted with respect to that of FIG. 2. For example, the spacing between rows of touch points 140 is about the same as the spacing between columns, yielding a square grid. In this case the vertical axis is scaled, e.g. compressed, as compared to the vertical axis of the grid in FIG. 2. Scaling, if used, may be greater or less than unity. While the touch points 140 are located at different physical locations on the screen 130 than in FIG. 2, the touch points 140 in the distorted coordinate space may be located at coordinate points that are the same as the touch points 140 in the coordinate space of FIG. 2.

An unlocking pattern 310 again connects four touch points 140. The unlocking pattern 310 is similar to the unlocking pattern 210, e.g. in that it connects touch points 140 at the upper left, middle, lower right and lower middle of the array. However, there is no requirement that this be true. More generally, the unlocking pattern 310 may include more or fewer touch points 140 than does the unlocking pattern 210, and the path taken in the unlocking pattern 210 may bear little or no resemblance to that taken in the unlocking pattern 310. However the similarity of the unlocking patterns 210, 310 in the illustrated example is instructive in that because the coordinate space of FIG. 3 is distorted as compared to that of FIG. 2, and vice versa, the paths do not overlap. Thus, any smudging on the touch screen 130 will be spread out and less likely to be interpretable by a malicious actor attempting to gain access to the mobile device.

In various embodiments the user is required to enter two unlocking patterns. In a first unlocking step, the user enters a first unlocking pattern based on a first coordinate space of the touch screen, e.g. the coordinate space of FIG. 2. In a second unlocking step, the user enters a second unlocking pattern based on a second coordinate space, e.g. the coordinate space of FIG. 3. The processor 110 detects contact with the touch points 140 using the appropriate coordinate space. Thus while the upper-left touch point 140 in FIG. 3 may not be in the same physical location on the touch screen 130 as the upper left touch point 140 in FIG. 2, the processor 110 interprets both as the same location in the array of touch points 140. Optionally, the processor may be further configured to allow the user to specify a maximum duration within which the first unlocking pattern in the first unlocking step and the second unlocking pattern in the second unlocking step must be properly executed to unlock the apparatus.

In general the processor 110 requires that each of the unlocking patterns used in the first and second unlocking steps be a recognized pattern, e.g. stored in the memory 120. A recognized pattern may be stored by the user in the memory 120, and may be referred to herein as a “registered pattern.” More than one registered pattern may be stored in memory, and the first and second unlocking patterns may be different from each other. Such operation may be configured by user selection, for example. The user may also configure the distortion types used in each of the first and second unlocking step. In some embodiments, the processor 110 requires that both the first and second unlocking patterns be a same unlocking pattern, as interpreted in the different coordinate spaces. Because the physical locations of the touch points 140 in one coordinate space are shifted relative to corresponding touch points 140 in another coordinate space, any smudging on the touch screen 130 is expected to be less suitable for a smudge attack, advantageously improving security of the mobile device.

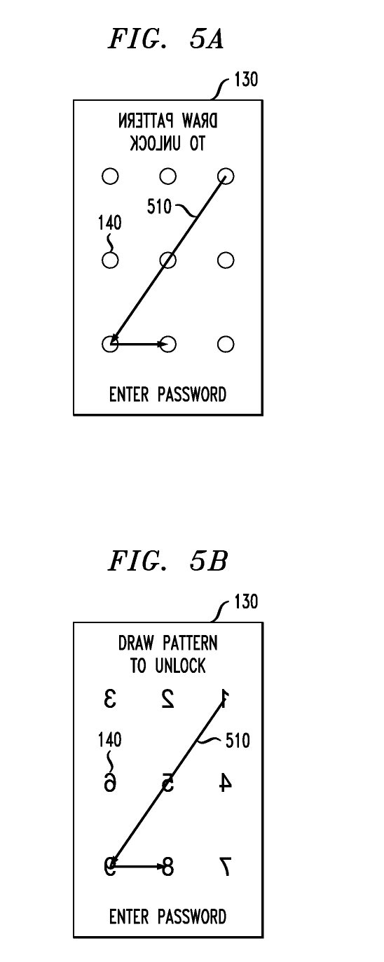

FIGS. 4, 5A/B and 6A/B extend the preceding principle to additional distortions that may be beneficial in some embodiments. In FIG. 4, the touch screen 130 has touch points 140 placed in yet another different coordinate space. In this case, the touch points are located at the vertices of an array of parallelograms. The coordinate space is referred to as a “skewed” coordinate space, and the resulting grid is referred to as a skewed grid, wherein the axes of the coordinate space cross at an angle other than 90 degrees. Thus the coordinate space of FIG. 4 is not rectilinear, and is distorted with respect to the coordinate spaces in FIGS. 2 and 3. An unlocking pattern 410 connects the touch points 140 in a pattern of same coordinate points as the patterns 210 and 310, though the pattern 410 only appears superficially similar to the patterns 210, 310. The similarity may be beneficial to a user, in that the user only needs to remember a single unlocking pattern. However, because of the touch points 140 are significantly shifted from the physical locations in, e.g. FIG. 2, smudging that results from the first and second unlocking steps is expected to be poorly correlated, further enhancing security, making it difficult for an attacker to perceive the unlocking pattern in the smudges.

FIG. 5A illustrates an embodiment in which the coordinate space of FIG. 2 is left-right reversed. Thus the coordinate space of FIG. 5A may be referred to as a mirror image distorted coordinate space. An unlocking pattern 510 that corresponds to the unlocking pattern 210 of FIG. 2 begins at the upper right of the touch point 140 grid and extends to the lower left before ending at the bottom middle touch point 140. An unlocking pattern in the coordinate space of FIG. 2 may be chosen that correlates poorly with a mirror-image unlocking pattern in the mirror image distorted coordinate space of FIG. 5A, making a smudge attack difficult.

In the embodiment of FIG. 5A, the touch point 140 indicia are unchanged with the left-right reversal. Thus a user could have difficulty recognizing the presence of the distorted coordinate space without some visual cue. In FIG. 5A, the instructional phrase “Draw Pattern to Unlock” is rendered from right to left, providing a visual indication to the user that the mirror image distorted coordinate space is active. FIG. 5B presents another embodiment, in which numerical indicia are assigned to each touch point 140. The indicia may be rendered un-reversed, with the location of the corresponding numerals serving to inform the user that the mirror image distorted coordinate space is active. In some embodiments, such as that illustrated, the numerical indicia may be reversed, providing an additional visual signal regarding the state of the coordinate space.

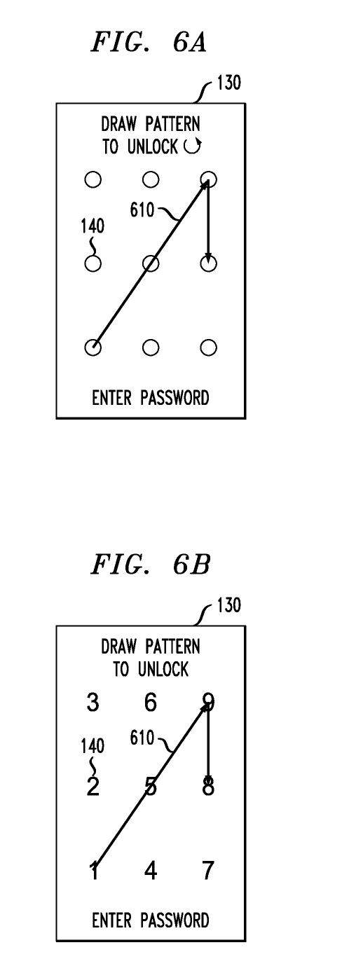

FIG. 6A illustrates an embodiment in which the coordinate space of FIG. 2 is rotated 90 degrees counter-clockwise. Thus the coordinate space of FIG. 6A may be referred to as a rotationally distorted coordinate space. An unlocking pattern 610 that corresponds to the unlocking pattern 210 of FIG. 2 begins at the lower left of the touch point 140 grid and extends to the upper right before ending at the middle right touch point 140. An unlocking pattern in the coordinate space of FIG. 2 may be chosen that correlates poorly with a rotationally distorted unlocking pattern in the coordinate space of FIG. 6A, again making a smudge attack difficult.

The embodiment of FIG. 6A includes a visual cue to alert the user of the status of the coordinate space, e.g. a rotation symbol “ [symbol] ” that follows the phrase “Draw Pattern to Unlock”. FIG. 6B illustrates an embodiment in which numerical indicia show the assigned position of each touch point 140. Such positioning also serves to provide the visual alert to the user.

It is noted that the example of coordinate space distortion described in the foregoing embodiments are not exclusive of other types of distortion that may be used within the scope of the described embodiments and the claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they formally fall within the scope of the claims.

The description and drawings merely illustrate the principles of the invention. It will thus be appreciated that those of ordinary skill in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, application specific integrated circuit (ASIC), field programmable gate array (FPGA), read only memory (ROM) for storing software, random access memory (RAM), and non volatile storage. Other hardware, conventional and/or custom, may also be included. Similarly, any Fes shown in the figures are conceptual only. Their function may be carried out through the operation of program logic, through dedicated logic, through the interaction of program control and dedicated logic, in conjunction with the appropriate computer hardware, the particular technique being selectable by the implementer as more specifically understood from the context.

It should be appreciated by those of ordinary skill in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Although multiple embodiments of the present invention have been illustrated in the accompanying Drawings and described in the foregoing Detailed Description, it should be understood that the present invention is not limited to the disclosed embodiments, but is capable of numerous rearrangements, modifications and substitutions without departing from the invention as set forth and defined by the following claims.

1. An apparatus, comprising:
a touch screen;
a processor; and
a memory coupled to said processor, said memory containing instructions that when executed configure the processor to:
in a first unlocking, to detect a first unlocking pattern based on a first coordinate space of said touch screen; and
in a second unlocking, to detect a second unlocking pattern based on a second coordinate space of said touch screen that is a distortion of said first coordinate space of said touch screen.

2. The apparatus of claim 1, wherein said processor is a component of a portable electronic device, and is further configured by said instructions to unlock said device only on the condition that said first unlocking pattern and said second unlocking pattern are both registered unlocking patterns.

3. The apparatus of claim 1, wherein said processor is further configured by said instructions to, in said first unlocking, display a first pattern of indicia at coordinate points in said first coordinate space, and in said second unlocking to display a second pattern of indicia at same coordinate points in said second coordinate space.

4. The apparatus of claim 3, wherein said processor is further configured to display said first pattern of indicia or said second pattern of indicia in a manner that conveys to a user the type of distortion.

5. The apparatus of claim 1, wherein said second unlocking pattern is a distorted version of said first unlocking pattern.

6. The apparatus of claim 1, wherein said processor is configured to allow access only on the condition that said touch screen registers a first correct unlocking pattern in said first unlocking, and registers a second correct unlocking pattern in said second unlocking, wherein said second unlocking pattern is a distorted version of said first unlocking pattern.

7. The apparatus of claim 1, wherein said second coordinate space is scaled in at least one dimension relative to said first coordinate space.

8. The apparatus of claim 1, wherein said second coordinate space is skewed with respect to said first coordinate space.

9. The apparatus of claim 1, wherein said second coordinate space is rotated with respect to said first coordinate space.

10. The apparatus of claim 1, wherein said second coordinate space is at least two of scaled, skewed and rotated with respect to said first coordinate space.

11. The apparatus of claim 1, wherein said processor is configured to allow a user to specify a sequence of a first unlocking pattern in said first unlocking and a second unlocking pattern in said second unlocking required to unlock said apparatus.

12. The apparatus of claim 1, wherein said processor is further configured to allow a user to specify a maximum duration within which a first unlocking pattern in said first unlocking and a second unlocking pattern in said second unlocking must be properly executed to unlock said apparatus.

13. A method, comprising:
configuring processor to receive touch input from a touch screen;
configuring said processor to receive instructions from a memory, said instructions when executed by said processor configuring said processor to:
in a first unlocking, detect a first unlocking pattern from said touch screen based on a first coordinate space of said touch screen; and
in a second unlocking, detect a second unlocking pattern from said touch screen based on a second coordinate space of said touch screen that is a distortion of said first coordinate space of said touch screen.

14. The method of claim 13, wherein said processor is a component of a portable electronic device, and is further configured by said instructions to unlock said device only on the condition that said first unlocking pattern and said second unlocking pattern are both registered unlocking patterns.

15. The method of claim 13, wherein said processor is further configured by said instructions to, in said first unlocking, display a first pattern of indicia at coordinate points in said first coordinate space, and in said second unlocking to display a second pattern of indicia at same coordinate points in said second coordinate space.

16. The method of claim 15, wherein said processor is further configured by said instructions to display said first pattern of indicia or said second pattern of indicia in a manner that conveys to a user the type of distortion.

17. The method of claim 13, wherein said second unlocking pattern is a distorted version of said first unlocking pattern.

18. The method of claim 13, wherein said processor is further configured by said instructions to allow access only on the condition that said touch screen registers a first correct unlocking pattern in said first unlocking, and registers a second correct unlocking pattern in said second unlocking, wherein said second unlocking pattern is a distorted version of said first unlocking pattern.

19. The method of claim 13, wherein said second coordinate space is at least one of scaled, skewed and rotated with respect to said first coordinate space.

20. The method of claim 13, wherein said second coordinate space is at least two of scaled, skewed and rotated with respect to said first coordinate space.
